(19) United States
(12) Patent Application Publication
(10) Pub. No.: US 2004/0263981 A1
(43) Pub. Date: Dec. 30, 2004

(54) Diffractive optical element with anti-reflection coating

(76) Inventor: Christopher L. Coleman, Santa Clara, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/607,655

(22) Filed: Jun. 27, 2003

(51) Int. Cl. G02B 5/18; G02B 27/42

(52) U.S. Cl. 359/569; 359/558

(57) ABSTRACT

A diffractive optical element includes a substrate having a surface relief pattern formed on a first side thereof. The diffractive optical element includes an anti-reflection coating formed on the surface relief pattern, thereby forming a coated surface relief pattern with substantially the same dimensions as the surface relief pattern formed on the substrate.

### THE FIELD OF THE INVENTION

The present invention generally relates to optical elements, and more particularly to a diffractive optical element with an anti-reflection coating.

### BACKGROUND OF THE INVENTION

A diffractive optical element is a type of optical element that diffracts light by producing changes in the amplitude, phase, or both the amplitude and phase, of an incident light wave. There are various types of diffractive optical elements, including diffraction gratings and holograms. Diffractive optical elements may be employed in transmission geometries (e.g., transmission gratings), which are designed to allow light to pass through the diffractive optical element, as well as in reflection geometries (e.g., reflection gratings), which are designed to reflect light.

Diffractive optical elements are commonly made with semiconductor processing techniques and are, therefore, conveniently made in materials such as silicon or compound semiconductors (e.g., gallium arsenide). However, as optical materials, semiconductors tend to have large indices of refraction, as compared to air, and typically give a very strong reflection signal (e.g., about 30 % per surface) when the elements are illuminated. In order to reduce the amount of light lost to reflection, an anti-reflection (AR) coating can be deposited onto the surface of the diffractive element. The method in which the anti-reflection coating is deposited can change the geometry of the final wafer surface, and the operation of the resulting diffractive optical element. With conventional plasma-assisted deposition techniques, applying a coating thickness that is comparable in dimension to the surface features of the diffractive element can corrupt the optical function of the element.

### SUMMARY OF THE INVENTION

One form of the present invention provides a diffractive optical element that includes a substrate having a surface relief pattern formed on a first side thereof. The diffractive optical element includes an anti-reflection coating formed on the surface relief pattern, thereby forming a coated surface relief pattern with substantially the same dimensions as the surface relief pattern formed on the substrate.

### BRIEF DESCRIPTION OF THE DRAWINGS

FIG. 1 is a diagram illustrating a side view of a prior art diffractive optical element with no anti-reflection coating.

FIG. 2 is a diagram illustrating a side view of a prior art diffractive optical element with a conformal anti-reflection coating.

FIG. 3 is a diagram illustrating a side view of a diffractive optical element with a top-only anti-reflection coating according to one embodiment of the present invention.

FIG. 4 is a graph illustrating simulated performances of a diffractive optical element with no anti-reflection coating, a diffractive optical element with a conformal anti-reflection coating, and a diffractive optical element with a top-only anti-reflection coating according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

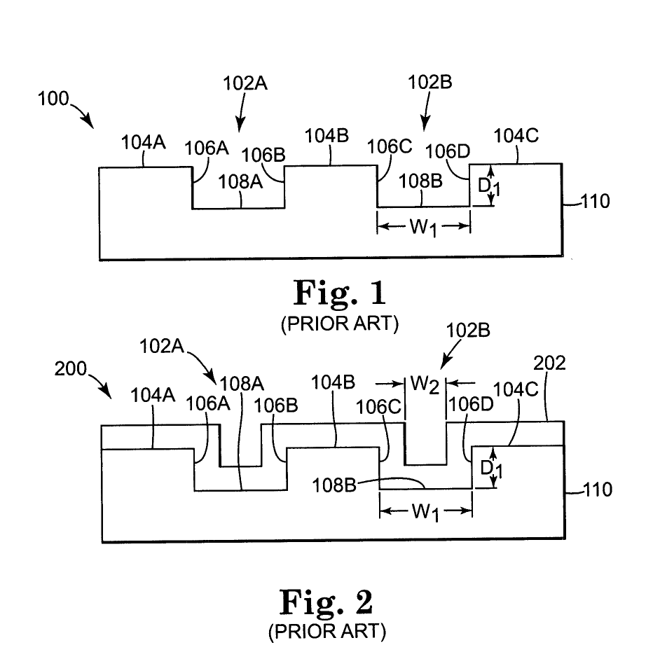

FIG. 1 is a diagram illustrating a side view of a prior art diffractive optical element 100 with no anti-reflection (AR) coating. Diffractive optical element 100 includes a substrate 110, with a plurality of grooves 102A-102B (collectively referred to as grooves 102) etched therein. Although only two grooves 102 are shown in FIG. 1 to simplify the illustration, many more grooves 102 are typically used in an actual implementation. In this example, the spacing between grooves 102 is a constant, such that the top surface of the substrate 110 has a periodic structure, which is referred to as a surface relief pattern.

Substrate 110 includes horizontal ridge surfaces 104A, 104B, and 104C, which are collectively referred to as horizontal surfaces 104. Groove 102A includes vertical sidewall surfaces 106A and 106B, and horizontal groove surface 108A. Groove 102B includes vertical sidewall surfaces 106C and 106D, and horizontal groove surface 108B. Vertical surfaces 106A-106D are collectively referred to as vertical surfaces 106, and horizontal surfaces 108A and 108B are collectively referred to as horizontal surfaces 108. Each groove 102 has a width, W₁, and a depth, D₁. The width, W₁, is a lateral dimension of the surface relief pattern, and the depth, D₁, is a vertical dimension of the surface relief pattern. The values for W₁ and D₁ will vary depending upon the particular application, and the wavelength of the light that is used for the application.

Since substrate 110 does not have an anti-reflection coating, a significant percentage of the light incident on the top surface of the substrate 110 may be reflected by the substrate 110. To reduce the amount of reflection by substrate 110, an anti-reflection coating can be added. FIG. 2 is a diagram illustrating a side view of a prior art diffractive optical element 200 with a conformal anti-reflection coating 202. Diffractive optical element 200 includes a substrate 110, which is configured in the same manner as shown in FIG. 1, and described above.

A conventional method of applying a coating layer to a wafer is to use a plasma-assisted deposition. The plasma-assisted deposition ends up depositing a conformal coating across the entire wafer surface, meaning that all exposed faces are coated evenly. As shown in FIG. 2, the conformal anti-reflection coating 202 evenly coats horizontal surfaces 104 and 108, as well as vertical surfaces 106. The conformal coating of all exposed surfaces of substrate 110 results in the effective width of each groove 102 being reduced, and the effective width of the ridge between each groove being increased. As shown in FIG. 2, the width of the grooves 102 is reduced from width, W₁, to width, W₂. For a width, W₁, of 524 nanometers, for example, and a coating thickness of 174 nanometers, the width, W₂, will be about 176 nanometers. Thus, for this example, the width of the air gap in grooves 102 is reduced by about sixty-six percent.

From modeling and experiments, it is seen that while a conformal coating (e.g., coating 202) does reduce reflections from a diffractive optical element (e.g., element 200), the conformal coating 202 can also degrade the ability of the element 200 to focus the light in transmission.

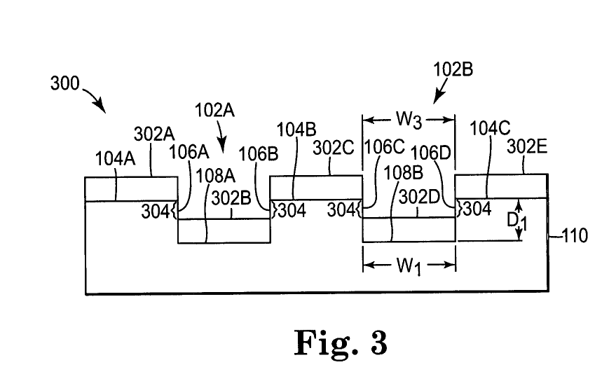

FIG. 3 is a diagram illustrating a side view of a diffractive optical element 300 with a top-only anti-reflection coating 302 according to one embodiment of the present invention. Diffractive optical element 300 includes a substrate 110, which is configured in the same manner as shown in FIG. 1, and described above. As shown in FIG. 3, anti-reflection coating portions 302A, 302C, and 302E are formed on horizontal surfaces 104A-104C, respectively, and anti-reflection coating portions 302B and 302D are formed on horizontal surfaces 108A and 108B, respectively. Anti-reflection coating portions 302A-302E are collectively referred to as “top-only” anti-reflection coating 302. The coating 302 is referred to as a “top-only” coating because only the top surfaces or horizontal surfaces (e.g., surfaces 104 and 108) are coated, as opposed to a conformal coating being evenly applied to all exposed surfaces. In one embodiment, a portion of each of the vertical surfaces 106 is partially covered by the top-only anti-reflection coating 302. As shown in FIG. 3, each of the vertical surfaces 106 is partially covered by the coating 302 from the horizontal surfaces 108 up to the top of the coating 302. In one form of the invention, a portion 304 of each vertical surface 106 is substantially free from any anti-reflection coating.

In another embodiment, the thickness of the anti-reflection coating 302 is greater than the depth, D₁, of the grooves 102. In this embodiment, each of the vertical surfaces 106 is completely covered by the top-only anti-reflection coating 302, but the structure of the surface relief pattern is retained. As shown in FIG. 3, the width, W₃, of each groove 102 in element 300 after the coating 302 is applied is the same as the width, W₁, of the groove 102 before the coating 302 is applied. Likewise, the width of the ridges between the grooves 102 is not changed by the coating 302. Thus, in one form of the invention, the addition of the top-only coating 302 does not change the dimensions of the surface relief pattern. In contrast, as shown in FIG. 2, with a conformal coating 202, the lateral dimensions of the element 200 are changed by the addition of the coating 202. With a conformal coating 202, the grooves 102 become narrower, and the ridges between the grooves 102 become wider, and therefore, the top surface of the element 200 becomes flatter. The conformal coating 202 obscures the original surface relief pattern formed in the substrate 110.

In one embodiment, diffractive optical element 300 is a transmission grating and substrate 110 is made from a semiconductor material, such as silicon or gallium arsenide. In another embodiment, substrate 110 is made from an optical material such as glass, plastic, or an epoxy. In one form of the invention, the width, W₁, of each groove 102 is between about 0.2 micrometers and 100 micrometers, and the depth, D₁, of each groove 102 is about 0.5 micrometers. In one embodiment, the width of the ridges between each groove 102 is substantially the same as the width, W₁, of the grooves 102.

In one embodiment, the top-only coating 302 is a “quarter-wave layer,” meaning that the thickness of the coating 302 is (λ/4)/N_{AR}, where “λ” represents the wavelength of the light being used in the application, and “N_{AR}” represents the index of refraction of the coating 302. In one form of the invention, coating 302 is a dielectric material, such as silicon nitride, titanium dioxide, or silicon dioxide. In one embodiment, coating 302 has an index of refraction, N_{AR}, of 1.87. In one embodiment, the diffractive optical element 300 is designed for infrared or near-infrared light. In one form of the invention, element 300 is designed for light with a wavelength of 1300 nanometers, and in another form, element 300 is designed for light with a wavelength of 1550 nanometers. Thus, in one embodiment, coating 302 is about 174 nanometers thick (i.e., (1300/4)/1.87) for a 1300 nanometer wavelength, and is about 207 nanometers thick (i.e., (1550/4)/1.87) for a 1550 nanometer wavelength.

In one embodiment, the top-only anti-reflection coating 302 is deposited at the wafer level using a directional deposition technique. In one embodiment, the top-only anti-reflection coating 302 is directionally deposited using evaporation, such as electron beam evaporation. In other embodiments of the present invention, coating 302 is directionally deposited using a sputtering technique. For example, the coating 302 may be directionally deposited using a very small magnetron sputtering target in a chamber configuration similar to that used for electron beam evaporation to provide collimation by distance and a small source. Alternatively, a conventional sputtering target can be used with a collimator positioned between the target and the substrate. For the technique using a conventional sputtering target and a collimator, the sputtering can be performed with or without a magnetron, the sputtering can be either radio frequency (RF) or direct current (DC), and the process can be either reactive or non-reactive.

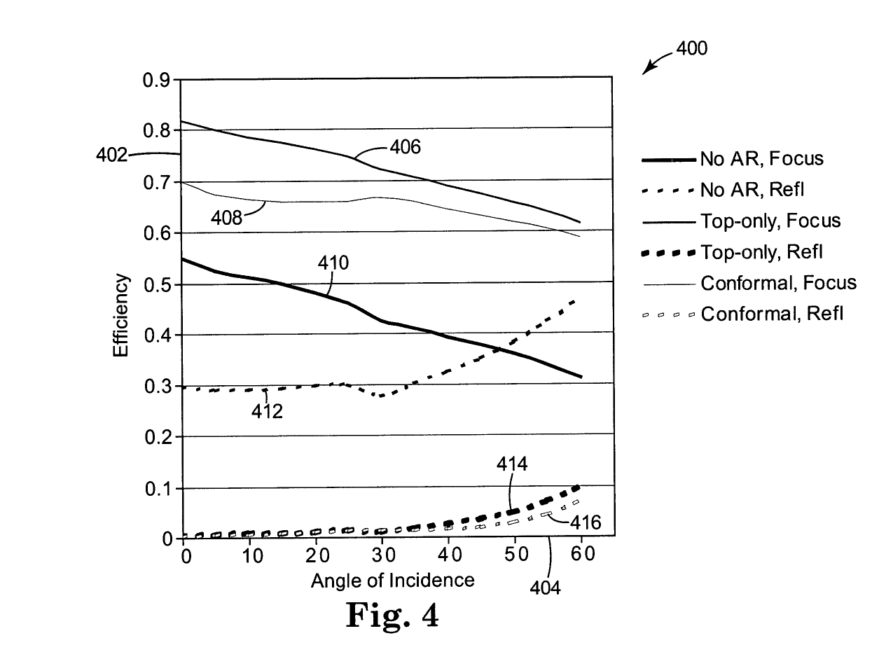

FIG. 4 is a graph 400 illustrating simulated performances of a diffractive optical element 100 (FIG. 1) with no anti-reflection coating, a diffractive optical element 200 (FIG. 2) with a conformal anti-reflection coating 202, and a diffractive optical element 300 (FIG. 3) with a top-only anti-reflection coating 302 according to one embodiment of the present invention. For the simulation, a silicon nitride anti-reflection coating with a thickness of 174 nanometers and an index of refraction of 1.87 was used. The substrate 110 used in the simulation was a silicon substrate with an index of refraction of 3.4969, and the grooves 102 had a depth, D₁, of 262 nanometers. A light wavelength of 1310 nanometers was used in the simulation.

The vertical axis 402 of graph 400 represents efficiency, which ranges from zero to ninety percent, and the horizontal axis 404 of graph 400 represents the angle of incidence, which ranges from zero degrees to about sixty-five degrees. An angle of incidence of zero degrees represents a light ray that is perpendicular to the top surface of the diffractive optical element.

Graph 400 includes six curves 406-416. Curve 410 illustrates the “focus” simulation results for a diffractive optical element 100 with no anti-reflection coating. The “focus” simulation results indicate the percentage of light incident on the diffractive optical element that is properly scattered by the element (i.e., transmitted through the element and scattered in a desired direction). As can be seen from curve 410, for a zero degree angle of incidence, the element 100 with no anti-reflection coating properly focuses about fifty-five percent of the light that is incident on the element 100. Curve 412 illustrates the reflection simulation results for a diffractive optical element 100 with no anti-reflection coating. As can be seen from curve 412, for a zero degree angle of incidence, the element 100 with no anti-reflection coating reflects about thirty percent of the light that is incident on the element 100. The focus percentage (i.e., 55%) and the reflection percentage (i.e., 30%) do not add up to one hundred percent. The remaining light (i.e., 15%) incident on the element 100 is transmitted through the element 100, but is not focused (i.e., the remaining light is scattered in an undesirable direction).

Curve 408 illustrates the focus simulation results for a diffractive optical element 200 with a conformal anti-reflection coating 202. As can be seen from curve 408, for a zero degree angle of incidence, the element 200 with a conformal anti-reflection coating 202 properly focuses about seventy percent of the light that is incident on the element 200. Curve 416 illustrates the reflection simulation results for a diffractive optical element 200 with a conformal anti-reflection coating 202. As can be seen from curve 416, for a zero degree angle of incidence, the element 200 with a conformal anti-reflection coating 202 reflects a very small percentage (i.e., close to zero) of the light that is incident on the element 200.

Curve 406 illustrates the focus simulation results for a diffractive optical element 300 with a top-only anti-reflection coating 302 according to one embodiment of the present invention. As can be seen from curve 406, for a zero degree angle of incidence, the element 300 with a top-only anti-reflection coating 302 properly focuses over eighty percent of the light incident on the element 300. Curve 414 illustrates the reflection simulation results for the diffractive optical element 300 with a top-only anti-reflection coating 302 according to one embodiment of the present invention. As can be seen from curve 414, for a zero degree angle of incidence, the element 300 with a top-only anti-reflection coating 302 reflects a very small percentage (i.e., close to zero) of the light that is incident on the element 300.

The simulation results shown in FIG. 4 indicate that both the conformal coating 202 and the top-only coating 302 geometries reduce the reflections from the surface. However, the top-only coating 302 shows better overall lens performance. With the conformal coating 202, the features of the diffractive optical element 200 begin to lose their effectiveness to focus the light. So while most of the light does become transmitted through element 200, a smaller percentage of the light gets scattered into the desired directions than with element 300.

An explanation for the difference in lens performance between an element with a conformal coating 202 and an element with a top-only coating 302 is that the conformal coating 202 evenly coats the sides of the surface relief features (e.g., vertical surfaces 106), and thereby begins to fill in the air gap between the features, effectively reducing the presence of the features and the ability of the features to influence the light. The top-only coating 302, on the other hand, according to one form of the invention, has no smoothing effect on the surface relief features, and is able to faithfully reproduce the same surface relief pattern at its top surface. As can be seen in FIG. 4, the reflection from the top-only coating 302 is reduced without compromising the lens performance in transmission. With the top-only coating 302, a greater fraction of the light is bent into the desired direction by the element 300 than by the element 200 with a conformal coating 202. Since the difference between the two coating geometries 202 and 302 can be explained by “lost” features that get filled in, it follows that the improvement provided by the top-only coating 302 is greater for designs with smaller lateral dimensions.

The simulation results illustrated in FIG. 4 have been confirmed by actual test results. In the test, a top-only anti-reflection coating was deposited on a diffractive optical element using an evaporator, and then compared to a similar diffractive optical element with a conformal coating applied with a plasma-assisted vapor deposition. The measured results of the two diffractive optical elements showed that the diffractive optical element with the top-only coating had an advantage over the element with the conformal coating. More energy was focused in the desired direction by the element having the top-only coating than by the element with the conformal coating, consistent with the simulation results shown in FIG. 4.

One embodiment of the present invention provides a diffractive optical element with an efficient anti-reflection coating. One form of the present invention provides a method for depositing an anti-reflection coating on a diffractive optical element, in such a way that the reflection of the surface is reduced without degrading the ability of the element to bend the light. The anti-reflection coating according to one embodiment is especially valuable when the diffractive optical element is made in a semiconductor, since semiconductor materials have a large amount of natural reflection that would otherwise limit the efficiency of the diffractive element.

Although the embodiment of the surface relief pattern shown in FIGS. 1-3 is a square wave type pattern, with horizontal or lateral surfaces 104 and 108 that are parallel to a longitudinal plane of the substrate, and vertical surfaces 106 that are perpendicular to the longitudinal plane, further embodiments of the present invention use other types of surface relief patterns. Various types of surface relief patterns are known to those of ordinary skill in the art.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A diffractive optical element, comprising:
a substrate having a surface relief pattern formed on a first side thereof; and
an anti-reflection coating formed on the surface relief pattern, thereby forming a coated surface relief pattern with substantially the same dimensions as the surface relief pattern formed on the substrate.

2. The diffractive optical element of claim 1, wherein the substrate is a semiconductor material.

3. The diffractive optical element of claim 1, wherein the diffractive optical element is a transmission grating.

4. The diffractive optical element of claim 1, wherein the anti-reflection coating is a dielectric material.

5. The diffractive optical element of claim 4, wherein the anti-reflection coating is selected from the group consisting of silicon nitride, titanium dioxide, and silicon dioxide.

6. The diffractive optical element of claim 1, wherein the anti-reflection coating is applied by a directional deposition technique.

7. The diffractive optical element of claim 1, wherein the surface relief pattern formed on the substrate includes a first set of surfaces that are each substantially parallel to a longitudinal plane of the substrate, and a second set of surfaces that are each substantially perpendicular to the longitudinal plane, and wherein each of the surfaces in the second set includes a surface portion that is substantially free from the anti-reflection coating.

8. The diffractive optical element of claim 7, wherein each of the surfaces in the first set is substantially covered by the anti-reflection coating.

9. A method of forming a substantially anti-reflective diffractive optical element, comprising:
providing a substrate;
forming a surface relief pattern on a first side of the substrate; and
directionally depositing an anti-reflection coating on the surface relief pattern, thereby substantially maintaining dimensions of the surface relief pattern.

10. The method of claim 9, wherein the substrate is a semiconductor material.

11. The method of claim 9, wherein the anti-reflection coating is a dielectric material.

12. The method of claim 11, wherein the anti-reflection coating is selected from the group consisting of silicon nitride, titanium dioxide, and silicon dioxide.

13. The method of claim 9, wherein the anti-reflection coating is deposited by evaporation.

14. The method of claim 13, wherein the anti-reflection coating is deposited by electron beam evaporation.

15. The method of claim 9, wherein the anti-reflection coating is deposited by sputtering.

16. A diffractive optical element, comprising:
a substrate having a first side with a plurality of light diffracting features, the light diffracting features each having a width dimension parallel to a longitudinal plane of the substrate; and
an anti-reflection coating formed on the first side of the substrate, thereby forming a plurality of coated light diffracting features, the coated features each having a width dimension that is substantially the same as the width dimension of a corresponding one of the light diffracting features of the substrate.

17. The diffractive optical element of claim 16, wherein the substrate is a semiconductor material.

18. The diffractive optical element of claim 16, wherein the anti-reflection coating is a dielectric material.

19. The diffractive optical element of claim 16, wherein the anti-reflection coating is applied by a directional deposition technique.

20. The diffractive optical element of claim 16, wherein the plurality of light diffracting features of the substrate include a first set of surfaces that are each substantially parallel to the longitudinal plane of the substrate, and a second set of surfaces that are each substantially perpendicular to the longitudinal plane, and wherein each of the surfaces in the second set includes a surface portion that is substantially free from the anti-reflection coating.
